(19) United States
(12) Patent Application Publication
(10) Pub. No.: US 2017/0366127 A1
(43) Pub. Date: Dec. 21, 2017

(54) REGULATION OF A DRIVE DEVICE

(71) Applicant: SIMEMENS AKTIENGESELLSCHAFT, München (DE)

(72) Inventor: IOANNIS TSOUMAS, Zürich (CH)

(73) Assignee: SIMEMENS AKTIENGESELLSCHAFT, München (DE)

(21) Appl. No.: 15/542,834

(22) PCT Filed: Nov. 27, 2015
(86) PCT No.: PCT/EP2015/077938

§ 371 Date: Jul. 11, 2017

(30) Foreign Application Priority Data
Jan. 12, 2015 (EP) 15150780.3

(51) Int. Cl. H02P 23/02

(52) U.S. Cl. CPC H02P 23/02

(57) ABSTRACT

A method and a control device for regulating a drive device includes an electric motor with a motor shaft and a converter for supplying power to the electric motor. To this end, measured values of measured variables, which characterize a power loss of the drive device, are detected and a converter output voltage is adjusted depending on the detected measured values in such a way that the power loss decreases.

The invention relates to a method and a control device for regulating a drive device which features an electric motor with a motor shaft and a converter for supplying power to the electric motor.

The use of variable-speed drive devices in industry can result in a substantial increase in process efficiency and therefore a reduction in production and product costs. In this regard, process efficiency can be further increased with the aid of an optimized regulation of the drive devices.

The object underlying the invention is to specify an improved method and an improved control device for regulating a drive device.

According to the invention the object is achieved by the features in claim 1 in terms of the method and by the features in claim 12 in terms of the control device.

Advantageous embodiment variants of the invention form the subject matter of the dependent claims.

The inventive method is used for regulating a drive device which features an electric motor with a motor shaft and a converter for supplying power to the electric motor. In this regard measured values of measured variables which characterize a power loss of the drive device are detected and a converter output voltage of the converter is adjusted depending on the detected measured values in such a way that the power loss decreases.

Advantageously the method makes it possible to raise the efficiency of a converter-fed drive device by means of a reduction in a power loss of the drive device. This is achieved by regulating the converter output voltage depending on measured values of measured variables which characterize the power loss.

In this regard a motor speed of the motor shaft and/or an output current of the converter and/or an input voltage of the converter and/or an input current of the converter are preferably used as measured variables. In the event that the converter features a rectifier and an inverter connected to the rectifier via an intermediate circuit, an intermediate circuit voltage of the intermediate circuit is furthermore preferably used as a measured variable.

These measured variables advantageously make it possible to determine the power loss of the drive device as the difference between an electrical input power at an input of the converter and a mechanical motor power of the motor by measuring or calculating the input power and/or motor power. For example the motor power can be determined from the motor speed of the motor shaft and the output current of the converter, and the input power from the input voltage and the input current of the converter.

For the purpose of regulating the converter output voltage, one output voltage target value of the converter output voltage is preferably determined in each case in successive regulation time intervals depending on the detected measured values and the converter output voltage is adjusted to the determined output voltage target value.

As a result the converter output voltage can be advantageously adapted continuously to the measured values detected in each case so that the power loss of the drive device can be continuously optimized.

In this regard the output voltage target value is preferably
either taken from a lookup table for the output voltage target value depending on values of the measured variables,
or calculated by using a mathematical model for calculating the output voltage target value depending on values of the measured variables,
or changed in a stepwise manner depending on the detected measured values, wherein measured values are detected in every regulation time interval and a power loss is determined from the measured values detected in each case, and a change direction of the change in the output voltage target value is changed compared with the change direction in the preceding regulation time interval if the determined power loss is increasing compared with a power loss determined in the preceding regulation time interval, and is maintained if the determined power loss is decreasing compared with a power loss determined in the preceding regulation time interval.

In this regard a change direction of the change in the output voltage target value is understood to mean a change in the output voltage target value toward smaller or larger values.

Each of these alternatives enables a continuous updating of the output voltage target value depending on the detected measured values of the measured variables. Using a lookup table has the advantage of requiring an especially low level of computing effort and as a result of being especially quick and easy to implement, although it does require the creation of a lookup table and consequently has little flexibility in the face of system changes, e.g. due to component change or wear. Using a mathematical model to calculate the output voltage target value is more flexible in comparison but it does require more computing time and effort, and also parameters for the mathematical model, the values of which are not always easy to define. Using a stepwise change in the output voltage target value depending on the detected measured values of the measured variables, in line with the third aforesaid alternative, is on the one hand flexible as regards system changes, since it is not dependent on the concrete components of the system, and apart from this it can be implemented with relatively little computing effort so that it combines advantages of the other two alternatives.

Further embodiment variants of the invention are directed toward a drive device the converter of which features a rectifier and an inverter connected to the rectifier via an intermediate circuit, wherein an intermediate circuit voltage of the intermediate circuit is adjusted by using the rectifier. In this regard, according to the invention, in addition to the converter output voltage, the intermediate circuit voltage is also adjusted depending on the detected measured values in such a way that the power loss decreases.

This advantageously enables an even more efficient reduction in the power loss of the drive device by a simultaneous regulation of the converter output voltage and the intermediate circuit voltage.

Similarly to the embodiment variants for regulating the converter output voltage already referred to above one intermediate circuit voltage target value of the intermediate circuit voltage is preferably determined in each case in successive regulation time intervals depending on the detected measured values and the intermediate circuit voltage is adjusted to the determined intermediate circuit voltage target value.

In this regard the intermediate circuit voltage target value is preferably
either taken from a lookup table for the intermediate circuit voltage target value depending on values of the measured variables,
or calculated by using a mathematical model for calculating the intermediate circuit voltage target value depending on values of the measured variables,
or changed in a stepwise manner depending on the detected measured values, wherein measured values are detected in every regulation time interval and a power loss is determined from the measured values detected in each case, and a change direction of the change in the intermediate circuit voltage target value is changed compared with the change direction in the preceding regulation time interval if the determined power loss is increasing compared with a power loss determined in the preceding regulation time interval, and is maintained if the determined power loss is decreasing compared with a power loss determined in the preceding regulation time interval.

These embodiment variants for regulating the intermediate circuit voltage correspond to the embodiment variants for regulating the converter output voltage already referred to above with the advantages similarly already referred to above.

An inventive control device for regulating a drive device in accordance with the inventive method comprises a measuring sensor for each measured variable for detecting measured values of the measured variables, an evaluation unit for evaluating the detected measured values, and a voltage regulator for regulating the converter output voltage depending on the detected and evaluated measured values.

In this regard the voltage regulator is preferably also realized for regulating an intermediate circuit voltage of an intermediate circuit between a rectifier and an inverter of the converter depending on the detected and evaluated measured values to the extent that the converter has an intermediate circuit with an intermediate circuit voltage capable of being adjusted via a rectifier.

A control device realized in such a manner makes it possible to implement the inventive method for regulating the drive device with the advantages referred to above.

The properties, features, and advantages of this invention described above and also the way in which these are achieved will become clearer and more plainly understandable in conjunction with the following description of exemplary embodiments which are explained in detail in conjunction with the drawings, in which:

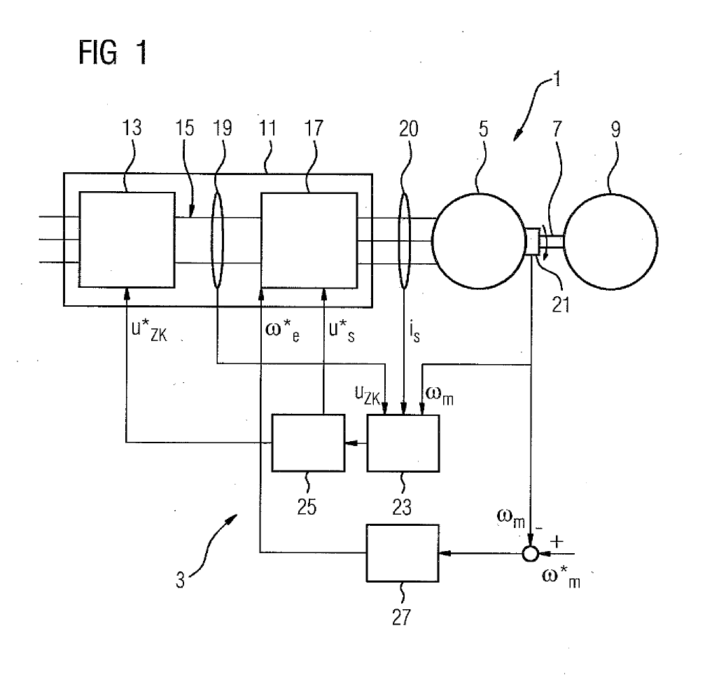

FIG. 1 shows a drive device and a control device for regulating the drive device, and

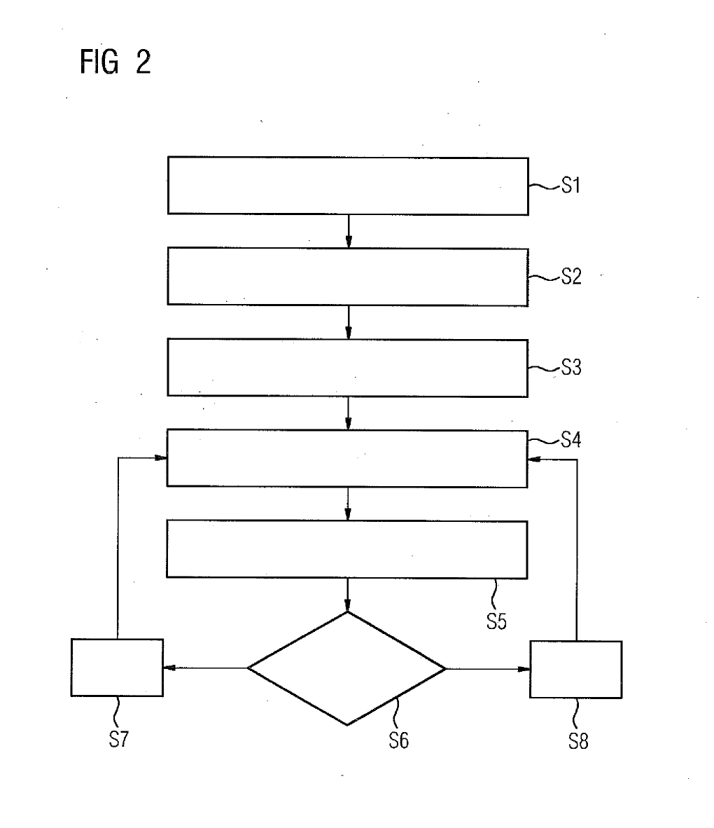

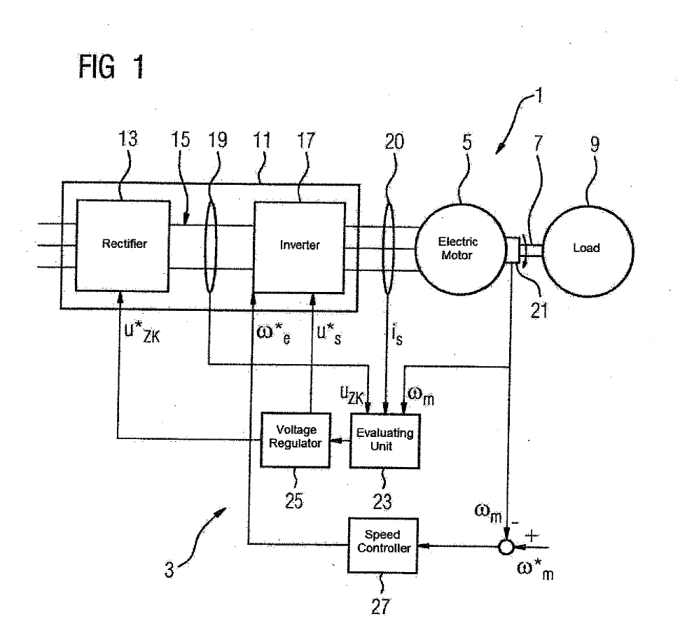

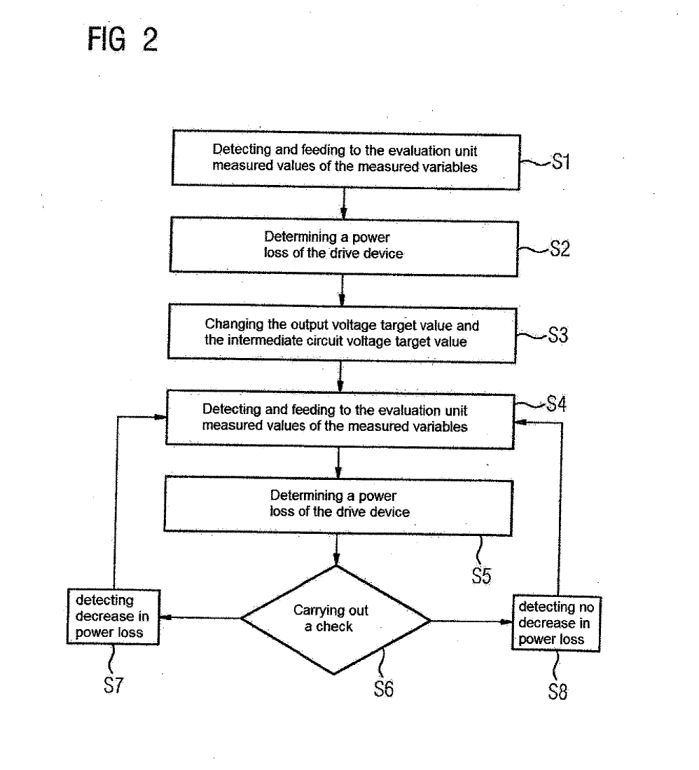

FIG. 2 shows a flow diagram of a method for regulating the drive device.

FIG. 1 shows a block diagram of a drive device 1 and a control device 3 for regulating the drive device 1.

The drive device 1 comprises an electric motor 5 with a motor shaft 7 for driving a load 9 and a converter 11 for supplying power to the electric motor 5. The converter 11 comprises a rectifier 13 and an inverter 17 connected to the rectifier 13 via an intermediate circuit 15, wherein an intermediate circuit voltage u_{ZK} of the intermediate circuit (15) is adjusted by using the rectifier 13.

The control device 3 comprises measuring sensors 19 to 21 for detecting measured values of a plurality of measured variables which characterize a power loss of the drive device 1, an evaluation unit 23 for evaluating the detected measured values, and a voltage regulator 25 for regulating a converter output voltage of the converter 11 and the intermediate circuit voltage u_{ZK} depending on the detected measured values. In this regard a power loss of the drive device 1 is defined as a difference in an electrical input power at an input of the converter 11 and a mechanical motor power of the motor 5.

The intermediate circuit voltage u_{ZK}, an output current i_{S} of the converter 11, and a motor speed ωₘ of the motor shaft 21 are used as measured variables in the exemplary embodiment represented. For each of these measured variables the control device 3 has a measuring sensor 19 to 21 which detects the measured values of the respective measured variable and feeds them to the evaluation unit 23.

By using the evaluation unit 23 and the voltage regulator 25 the converter output voltage and the intermediate circuit voltage u_{ZK} are adjusted depending on the detected measured values in such a way that the power loss of the drive device 1 decreases. To this end one output voltage target value u*_{S} of the converter output voltage and one intermediate circuit voltage target value u*_{ZK} of the intermediate circuit voltage u_{ZK} are updated in each case in successive regulation time intervals by the evaluation unit 23 depending on the detected measured values in the manner described in detail below. By using the voltage regulator 25 the converter output voltage is adjusted to the respective current output voltage target value u*_{S} and the intermediate circuit voltage u_{ZK} to the respective current intermediate circuit voltage target value u*_{ZK}.

Regulation of the motor speed ωₘ to a speed target value ω*ₘ is effected via a corresponding frequency target value ω*ₑ, to which an output frequency of the converter output voltage is adjusted by using a speed controller 27.

FIG. 2 shows a flow diagram of a method for regulating the drive device 1. In FIG. 2 the method is broken down in to eight method steps S1 to S8. In this regard three method steps S1 to S3 are carried out initially in a first regulation time interval and the other five method steps S4 to S8 form a method loop which is carried out repeatedly in one of the successive regulation time intervals in each case.

In the first regulation time interval measured values of the measured variables are firstly detected and fed to the evaluation unit 23 by using the measuring sensors 19 to 21 in a first method step S1. In a second method step S2 a power loss of the drive device 1 is determined, by using the evaluation unit 23, from the measured values detected in the first method step S1. In a third method step S3 the output voltage target value u*_{S} and the intermediate circuit voltage target value u*_{ZK} are changed in a predetermined change direction, i.e. toward smaller or larger values, by a predetermined change amount by using the evaluation unit 23, and by using the voltage regulator 25 the converter output voltage is adjusted to the changed output voltage target value u*_{S} and the intermediate circuit voltage u_{ZK} to the changed intermediate circuit voltage target value u*_{ZK}.

In the further regulation time intervals measured values of the measured variables are in each case firstly detected and fed to the evaluation unit 23 by using the measuring sensors 19 to 21 in a fourth method step S4 as in the first method step S1. In a fifth method step S5, similarly to the second method step S2, a power loss of the drive device 1 is determined, by using the evaluation unit 23, from the measured values detected in the fourth method step S4. In a sixth method step S6 a check is carried out by using the evaluation unit 23 as to whether the power loss determined in the fifth method step S5 has decreased compared with the power loss determined in the preceding regulation time interval. If the outcome of this check produces a decrease in the power loss the output voltage target value u*_{S} and the intermediate circuit voltage target value u*_{ZK} are changed in a change direction which accords with the change direction in the preceding regulation time interval in a seventh method step S7. Otherwise, i.e. if no decrease in the power loss was established in the sixth method step S6, the output voltage target value u*_{S} and the intermediate circuit voltage target value u*_{ZK} are changed in a change direction which is opposite to the change direction in the preceding regulation time interval in an eighth method step S8. In this regard the changes in the output voltage target value u*_{S} and the intermediate circuit voltage target value u*_{ZK} in the seventh method step S7 and/or eighth method step S8 are effected for example in each case by permanently predetermined amounts or by amounts dependent on the change in the power loss determined in the sixth method step SO. Furthermore the converter output voltage is adjusted to the changed output voltage target value u*_{S} and the intermediate circuit voltage to the changed intermediate circuit voltage target value u*_{ZK} by using the voltage regulator 25 in the seventh method step S7 or the eighth method step S8 respectively. The method loop containing the method steps S4 to S8 is repeated until the change in the determined power loss compared with the power loss determined in the preceding regulation time interval is less than a predetermined change value, or the converter output voltage reaches a predetermined output voltage maximum value or a predetermined output voltage minimum value, or the intermediate circuit voltage u_{ZK} reaches a predetermined intermediate circuit voltage maximum value or a predetermined intermediate circuit voltage minimum value.

As an alternative to the exemplary embodiment described above on the basis of FIG. 2, other exemplary embodiments of the method for regulating the drive device 1 provide that, in each regulation time interval, the output voltage target value u*_{S} and the intermediate circuit voltage target value u*_{ZK} are either taken from a lookup table for the output voltage target value u*_{S} and the intermediate circuit voltage target value u*_{ZK} depending on values of the measured variables or calculated by using a mathematical model for calculating the output voltage target value u*_{S} and the intermediate circuit voltage target value u*_{ZK} depending on values of the measured variables.

In cases where the drive device 1 has a converter 11 which has no intermediate circuit 15 (i.e. in the event of a direct converter 11, which is also referred to as a matrix converter) or a rectifier 11 realized in a simple fashion, which is not realized for regulating the intermediate circuit voltage u_{ZK}, then in a similar manner to the exemplary embodiments described above, in place of the converter output voltage and the intermediate circuit voltage u_{ZK}, only the converter output voltage is adjusted by changing the output voltage target value u*_{S}. It is possible furthermore, in cases where the drive device 1 has a converter 11 with an adjustable intermediate circuit voltage u_{ZK}, to only adjust the intermediate circuit voltage u_{ZK} directly and by way of this, the converter output voltage indirectly.

Furthermore the exemplary embodiments described above can be modified to the effect that, alternatively or additionally, other or further measured variables respectively which characterize a power loss of the drive device 1 are detected and evaluated, for example an input voltage and/or an input current of the converter 11 and/or an intermediate circuit current of the intermediate circuit 15 and/or a torque at the motor shaft 7.

Although the invention has been precisely illustrated and described in detail by means of preferred exemplary embodiments, the invention is not limited by the examples disclosed and other variations can be derived from same by a person skilled in the art without departing from the scope of protection of the invention.

1.-12. (canceled)

13. A method for regulating a drive device having an electric motor with a motor shaft and a converter for supplying power to the electric motor, said method comprising:
connecting an inverter of the converter to a rectifier of the converter via an intermediate circuit;
detecting in every regulation time measured values of measured variables commensurate with a power loss of the drive device;
determining the power loss from the measured values;
adjusting a converter output voltage of the converter;
adjusting by using the rectifier an intermediate circuit voltage of the intermediate circuit depending on the detected measured values in such a way that the power loss decreases;
determining an output voltage target value of the converter output voltage and an intermediate circuit voltage target value of the intermediate circuit in successive regulation time intervals depending on the detected measured values;
adjusting the converter output voltage to the determined output voltage target value;
adjusting the intermediate circuit voltage to the determined intermediate circuit voltage target value;
using an intermediate circuit voltage of the intermediate circuit as a measured variable;
changing the intermediate circuit voltage target value in a stepwise manner depending on the detected measured values until a change in the power loss compared to a power loss in a preceding regulation time interval is less than a predetermined change value, or the intermediate circuit voltage reaches a predetermined intermediate circuit voltage maximum value or a predetermined intermediate circuit voltage minimum value;
changing a direction of a change in the intermediate circuit voltage target value compared to a change of a direction in a preceding regulation time interval when the determined power loss is increasing compared with a power loss determined in a preceding regulation time interval; and
maintaining the change of the direction when the determined power loss is decreasing compared to the power loss determined in the preceding regulation time interval.

14. The method of claim 13, further comprising using a motor speed of the motor shaft as a measured variable.

15. The method of claim 13, further comprising using an output current of the converter as a measured variable.

16. The method of claim 13, further comprising using an input voltage of the converter as a measured variable.

17. The method of claim 13, further comprising using an input current of the converter as a measured variable.

18. The method of claim 13, further comprising:
taking the output voltage target value from a lookup table depending on values of the measured variables; or
calculating the output voltage target value by using a mathematical model depending on the values of the measured variables; or
changing in a stepwise manner depending on the detected measured values until a change in the power loss compared to a power loss in a preceding regulation time interval is less than a predetermined change value, or the converter output voltage reaches a predetermined output voltage maximum value or a predetermined output voltage minimum value;
changing a direction of a change in the output voltage target value compared to a change of a direction in a preceding regulation time interval when the determined power loss is increasing compared to a power loss determined in a preceding regulation time interval; and
maintaining the change of the direction of the output voltage target value when the determined power loss is decreasing compared to a power loss determined in a preceding regulation time interval.

19. A control device for regulating a drive device, comprising:
a measuring sensor configured to detect a measured value of a measured variable;
an evaluation unit configured to evaluate the detected measured value; and
a voltage regulator configured to regulate a converter output voltage and an intermediate circuit voltage depending on the detected and the evaluated measured value.
